(19) United States
(12) Patent Application Publication
(10) Pub. No.: US 2020/0195440 A1
(43) Pub. Date: Jun. 18, 2020

(54) SYSTEMS AND METHODS FOR HUMAN IDENTITY VERIFICATION

(71) Applicant: Miro Health, Inc., San Francisco, CA (US)

(72) Inventors: Shenly Glenn, San Francisco, CA (US); Rudra Singh, San Francisco, CA (US); Laura Rhodes, San Francisco, CA (US); Joel Mefford, San Francisco, CA (US)

(73) Assignee: Miro Health, Inc., San Francisco, CA (US)

(21) Appl. No.: 16/696,228

(22) Filed: Nov. 26, 2019

Related U.S. Application Data
(60) Provisional application No. 62/771,428, filed on Nov. 26, 2018.

(51) Int. Cl. H04L 9/32; G06F 21/40; G06F 21/32; G06F 21/45; H04L 29/06; H04L 9/08

(52) U.S. Cl. CPC H04L 9/3231; G06F 21/40; H04L 9/0822; G06F 21/45; H04L 63/0861; G06F 21/32

(57) ABSTRACT

A system and method for identity verification, including: receiving, from a first electronic device, a reference identification item associated with a user; receiving a first source identification item, produced in real time, that is also associated with the user; receiving a first analysis result from a first analysis operation analyzing the first source identification item with respect to the reference identification item; upon receiving the first analysis result, deleting the reference identification item; and authenticating the user based on the first analysis result.

### CROSS-REFERENCE TO RELATED APPLICATIONS

This application claims the benefit of U.S. Provisional Patent application Ser. No. 62/771,428, “SYSTEM FOR SECURE, REMOTE HUMAN IDENTITY VERIFICATION IN HEALTHCARE, AND CLINICAL RESEARCH”, Attorney Docket miro.00005.us.p.1, filed Nov. 26, 2018, the entire disclosure of which is incorporated by reference herein, in its entirety, for all purposes.

### BACKGROUND

In applications such as healthcare delivery, clinical research, and other programs that involve humans, verification of a participant's or patient's identity is critical for multiple reasons. In fact, requirements exist that are enforced by governmental agencies and regulatory authorities to ensure that prospective human research and healthcare participants freely consent to the terms of healthcare or research. It is essential at the time of human consent, evaluation, intervention, screen, assessment, or other points of contact that the human matches the presented state-issued ID, and that the human and the human's presented identity remains consistent across contact and/or participation. Typically, a research or healthcare staff member compares the likeness of a person's physical self to the picture displayed on a presented government-issued photo ID card or other accepted photo ID document. It is not permitted for authorized identity-verifying references nor a subset of information derived from authorized identity-verifying references to be stored or recorded.

In-person identity verification allows the verification of a human's physical likeness to that of their state-issued photo ID. It discourages “double-dipping,” the known practice in clinical research whereby an individual participates in a study multiple times by posing as different individuals through false identity documents. In-person identity verification also helps prevent false entry into research. In these cases, Person B, who may qualify or a research study or healthcare program, poses as Person A, who would not qualify for said study or program, during the qualification screen to help Person A gain access to healthcare or research program for which Person A is not qualified. In-person identity verification also helps prevent healthcare provision to the incorrect individual. For example, a grandchild obtaining a pharmaceutical medication that were prescribed to a grandparent.

For healthcare and research programs that would benefit from remote screen, consent, enrollment, assessment, intervention, and other healthcare and research provisions, there is a need for the remote verification of participant identities that meet governmental, regulatory, and oversight requirements while also protecting the privacy of the participants and the security of their identities and personal documents.

### SUMMARY

Embodiments herein provide technical solutions to the aforementioned and other technical problems.

In general, in one aspect, embodiments relate to a method for identity verification. The method can include: receiving, from a first electronic device, a reference identification item associated with a user; receiving a first source identification item, produced in real time, that is also associated with the user; receiving a first analysis result from a first analysis operation analyzing the first source identification item with respect to the reference identification item; upon receiving the first analysis result, deleting the reference identification item; and authenticating the user based on the first analysis result.

In general, in one aspect, embodiments relate to a system for identity verification. The system can include: a computer processor; and a verification module executing on the computer processor and configured to cause the computer processor to: receive, from a first electronic device, a reference identification item associated with a user; receive a first source identification item, produced in real time, that is also associated with the user; receive a first analysis result from a first analysis operation analyzing the first source identification item with respect to the reference identification item; upon receiving the first analysis result, deleting the reference identification item; and authenticate the user based on the first analysis result.

In general, in one aspect, embodiments relate to a non-transitory computer-readable storage medium including a plurality of instructions for identify verification. The plurality of instructions configured to execute on at least one computer processor to cause the at least one computer processor to: receive, from a first electronic device, a reference identification item associated with a user; receive a first source identification item, produced in real time, that is also associated with the user; receive a first analysis result from a first analysis operation analyzing the first source identification item with the reference identification item; upon receiving the first analysis result, deleting the reference identification item; and authenticate the user based on the first analysis result.

Other aspects of the invention will be apparent from the following description and the appended claims.

### BRIEF DESCRIPTION OF THE DRAWINGS

Embodiments are illustrated by way of example, and not by way of limitation, in the figures of the accompanying drawings and in which like reference numerals refer to similar elements.

FIG. 1 illustrates a schematic diagram of a system, in accordance with one or more embodiments of the invention.

FIG. 2 illustrates a schematic diagram of a system, in accordance with one or more embodiments.

FIG. 3 illustrates a flowchart of an exemplary process, in accordance with one or more embodiments of the invention.

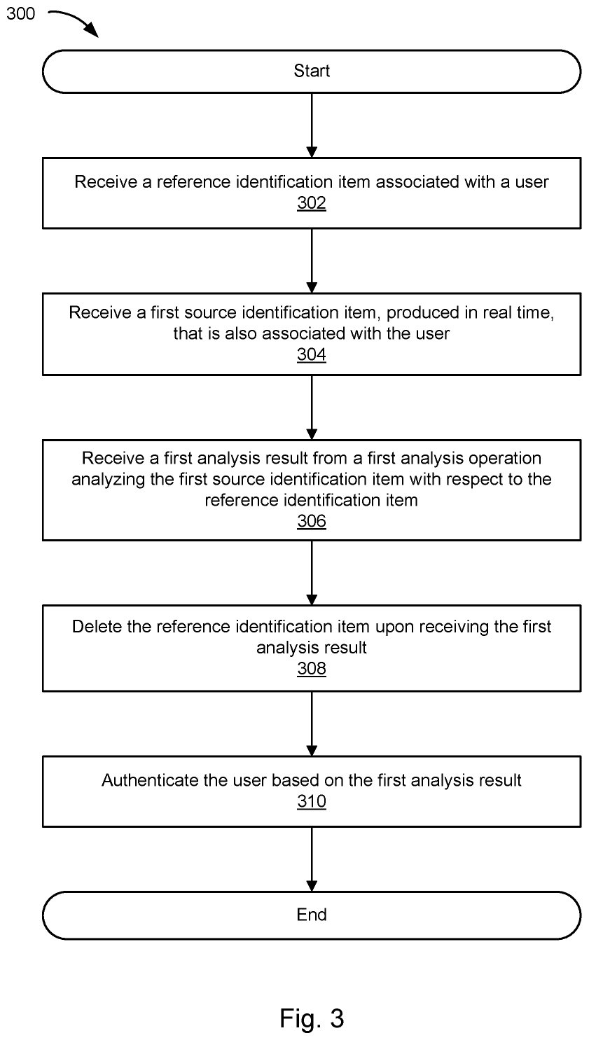

FIG. 4 illustrates an exemplary block diagram of a client device, in accordance with one or more embodiments of the invention.

FIG. 5 illustrates an exemplary block diagram of a computing system, in accordance with one or more embodiments of the invention.

### DETAILED DESCRIPTION

Specific embodiments will now be described in detail with reference to the accompanying figures. Like elements in the various figures are denoted by like reference numerals for consistency. In the following detailed description of embodiments, numerous specific details are set forth in order to provide a more thorough understanding of the invention. However, it will be apparent to one of ordinary skill in the art that the invention can be practiced without these specific details. In other instances, well-known features have not been described in detail to avoid unnecessarily complicating the description.

The present application includes novel systems and methods for remotely verifying an individual's identity without requiring an in-person meeting. The systems and methods for verification remain concordant with healthcare and clinical study regulations and guidelines. It should be understood that the systems and methods discussed herein are not limited to healthcare and clinical study settings, but apply to a multitude of settings that involve identity verification, for example, personal banking.

In general, embodiments of the present disclosure provide novel methods and systems that verify the sameness (or similarity) of an individual's biometric or personal identifier(s) captured in real-time, known here as source data, to the individual's equivalent identifier previously captured and verified by a commonly accepted identity-verification institution such as a governmental agency, bank, credit card issuer, or other financial institution, known here as reference data. For example, systems described herein may compare source data such as a photo taken of a person in real-time to reference data such as a state-issued driver's license. If it is determined that the source data (e.g., the real-time photo) adequately matches the reference data (e.g., the state-issued driver's license), then the identity of the individual may be verified (in other words, the individual may be authenticated). Accordingly, an individual's identify may be verified remotely, allowing the process to progress to the next stage (e.g., healthcare provision, clinical study facilitation, or any other process benefiting from identify verification). It should be appreciated that embodiments herein are not limited to remote verification because some or all embodiments may be performed locally “on-site”.

Further, the reference data may be deleted following the comparison of the source data with the reference data, or following identify verification. Accordingly, in some embodiments, the existence of the reference identification item is “ephemeral”. As a result, rules or regulations prohibiting the storage of certain forms of identification can be abided.

The reference data that captures a previously verified identity (e.g., state-issued identification (ID), driver's license, signature or fingerprint (such as from a reference data item such as a driver's license or credit card), voiceprint, or genetic/DNA code) and the source data (e.g., a “selfie” photo, fingerprint, voiceprint, signature, genetic code, or other personal biometric data) may be captured real-time through a secure web interface that employs the appropriate sensors on a digital device to capture the relevant data. For example, the sensor may be a camera that captures two pictures: (1) one of the state-issued photo ID and (2) the other of the person's head, face, and shoulders. The two digital files may then be encrypted and transmitted to two separate, secure, encrypted data stores with controlled access. One data store may securely house and preserve the human source data. The other data store may temporarily store the reference data.

In one or more embodiments, once the reference data has been viewed by authorized staff or by an analysis module (e.g., a data-driven software program) that registers the sameness between the source and reference data, the reference data is immediately and irrevocably erased from memory. Accordingly, in some embodiments, the existence of the reference identification item is “ephemeral”. In some embodiments, the sameness between source data and reference data is above a threshold amount in order to be verified. For example, reference data may show a younger person than source data, but the system may still verify that the person is the same person even though they look older, have a new hairstyle, etc.

In one or more embodiments, an analysis module (e.g., software) may scan multiple modalities of an individual's incoming source data and analyze it with respect to an individual's equivalent, existing source data modalities to determine the sameness (e.g., determine whether the modalities are verified as the same) of any given modality. Alternatively, incoming source data and existing source data can also be provided for human review of sameness per modality between or across identity verifying events.

A novel system is implemented to determine the uniqueness of each verified

identity and corresponding source data in the system. To do this, an analysis module (e.g., data-driven software) uses an equivalent approach to that described in above for each participant. Alternatively, source data for each participant across given modalities, with the exception of data from a non-reversible one-way hash, is displayed for human determination of sameness between and across non-identical identities. For example, if the source data is a non-reversible one-way hash (which may be encrypted), it may not be displayed for human determination, however it may be compared to previously stored one-way hashes.

In one or more embodiments, a user may only be verified if they consent (e.g., by signing a consent form). If a potential participant submits their reference data (e.g., ID) but does not sign consent within a threshold time (e.g., 1 business day), their source data (e.g., a “selfie”) and their reference data (e.g., a state-issued photo ID) will be erased from memory. In one or more embodiments, in response to a user (e.g., a potential participant) submitting their source data (e.g., identity verification photo(s)) and signing (e.g., consent for a clinical study), an authorized staff member may be notified that verification is required for a new user. Such notification may be sent via text message or provided via an alarm/notification.

In some embodiments, a user (e.g., an authorized study team member) must complete a two-step authentication process to access an identity verification application, which may be a web application (operable to capture images, audio, video, etc.). For example, in response to the authorized team member signing-in to an identity verification application, the potential participant's state-issued photo ID and their “selfie” may appear side-by-side on the same screen (e.g., a web page) as the potential participant's consent signature (which may be a signature taken at an earlier time or at the time of or within a certain amount of time of their “selfie” being taken). In one or more embodiments, an authorized study team member must indicate whether or not (1) a “selfie” and the state-issued photo ID photos are of the same person, and/or (2) a signature on the state-issued photo ID matches a signature on the consent (e.g., the potential participant's consent signature). In one or more embodiments, the indication may be made by pressing a button, or the study team member presenting a photo of themselves (e.g., taking a photo using their terminal) or another form of identification. In one or more embodiments, in response to a state-issued photo ID may be viewed for a limited amount of time (e.g., within 30 or 60 seconds), the state-issued photo ID may be erased from the system's memory, making it untraceable and unrecoverable, similar to the way that ephemeral photos and messages are deleted in Snapchat™.

In one or more embodiments, an authorized study team member may then co-sign and save the consent form (e.g., a paper and/or touch screen) together with the potential participant ID verification. In one or more embodiments, a “selfie” is stored on an encrypted medium separately from a consent form, and in some embodiments, the potential participant's state-issued photo-ID may be erased.

In one or more embodiments, such a manual verification process must take place within a period designated by a pre-authorized study team member that may be no longer than a threshold amount of time (e.g., 1 business day, a 24-hour period, etc.). Should review extend beyond the required verification period, in some embodiments, the state-issued ID will be automatically erased.

In one or more embodiments, consent, a subject image, personally identifiable, and/or personally protected health information may be encrypted and/or stored in separate digital containers. Further, in some embodiments, an identity verification application is accessible only to those who are granted permissions by the study owner (e.g., a person or non-human entity such as a company and/or research institution).

In one or more embodiments, a potential participant may identify their verification at a time of assessment (or within a threshold time of the time of assessment). For example, a picture of the potential participant's face (e.g., a “selfie”) and of the subject's state-issued photo ID may be taken separately via the system's assessment application at the time of assessment. The “selfie” may be stored in an encrypted data store, separate from other screening and/or study data (or in some embodiments, it may be stored and/or linked with the screening and/or study data). The photo of the state-issued photo ID may be temporarily held in an encrypted state in a separate data store from the “selfie” and from other screening and study data. In one or more embodiments, a potential participant's state-issued photo ID may be linked to the “selfie” by an encrypted key.

In one or more embodiments, if a potential participant submits their verification identification (e.g., reference data) but does not complete their assessment within a designated time frame, their “selfie” (e.g., source data) and state-issued photo ID (e.g., reference data) will be erased from memory. In some embodiments, in response to a potential participant submitting their identity verification photos (e.g., reference data), an authorized study team member may be notified that identity verification is required for a new potential participant. In some embodiments, a study team member must complete a two-step authentication process to access the identity verification application. Such an embodiment may provide additional security in the case that a study team member is compromised.

In one or more embodiments, an authorized study team member may sign-in, and a potential participant's state-issued photo ID and their “selfie” may appear side-by-side on the same screen (e.g., web page, or screen that shows information not-accessible by the Internet) as the “selfie” taken by the participant during a consent process. In some embodiments, the authorized study team member must indicate whether or not: (1) The “selfie” photo matches the state-issued photo ID photo, and/or (2) If the “selfie” taken at consent matches the “selfie” taken at the time of assessment. In one or more embodiments, in response to the state-issued photo ID taken at the time of assessment being viewed for a pre-determined time limit, the state-issued photo ID is erased from memory stores, making it untraceable and unrecoverable, similar to the way that ephemeral photos and messages are deleted in Snapchat™. The “selfie” is stored on an encrypted volume separately from the consent form (and the state-issued photo ID has been erased).

In some embodiments, a manual verification process must take place within a period designated by the study owner or by the system. In some embodiments, in response to a review extending beyond the required verification period, the state-issued ID (e.g., the reference data) will be erased.

In one or more embodiments, consent, a subject image, personally identifiable, and personally protected health information may be encrypted and stored in separate encrypted digital stores. Further, in one or more embodiments, an identity verification application is accessible only to those who are granted permissions by the study owner.

In one or more embodiments, participant identity verification confirmation may be the final portion of identifying a person.

For example, at the time of consent, a system transmutes a state-issued, identity verified image or audio file to text and stores it via a one-way hash in an encrypted data store, separate from all other data types. One-way hash encryption may ensure that the data on the photo ID cannot be unencrypted. Should a one-way hash at the time of consent match a one-way hash already in the system, the potential participant and session will be flagged as duplicate and sent for review (e.g., to one or more study team members). Should a one-way hash at the time of assessment match a one-way hash that is not the one-way hash at the time of consent, then a participant and session may be flagged/designated and sent for review.

In one or more embodiments, the authentication process may be asynchronous because the source data and reference data are reviewed for authentication at a time other than when they're provided (i.e., at a later time). As a result, asynchronous consent can be achieved (whereby an individual signs up and consents to a study without yet being approved).

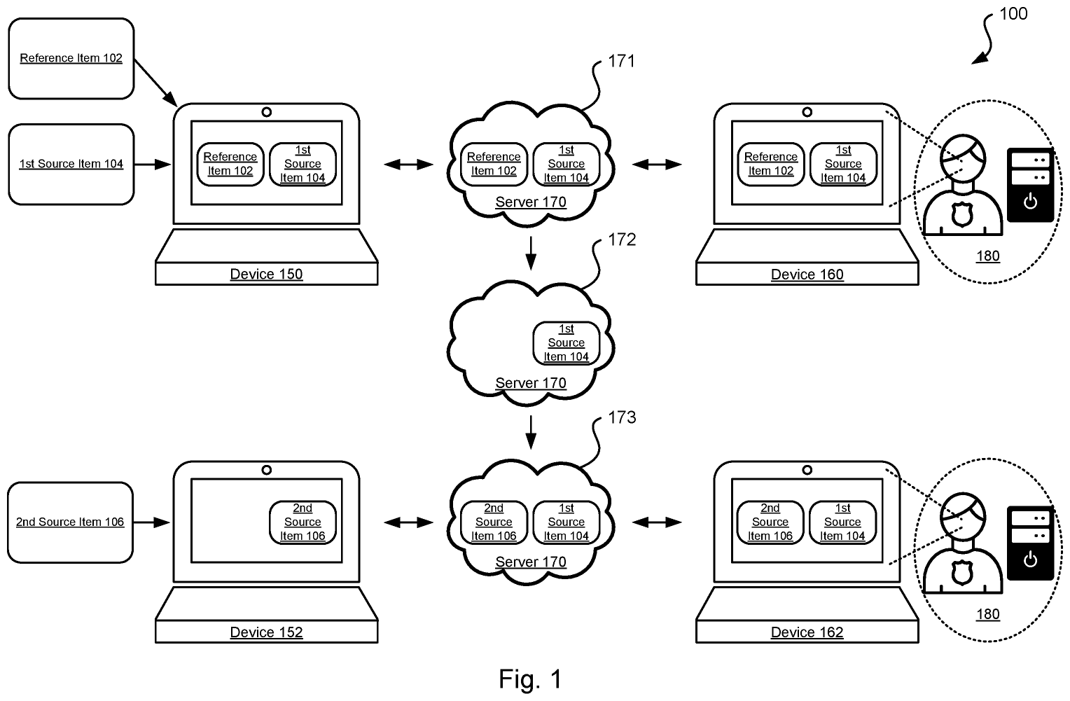

FIG. 1 illustrates a schematic diagram of a system 100, in accordance with one or more embodiments. In one or more embodiments, the system 100 includes functionality to receive, from a first electronic device, a reference identification item associated with a user. For example, with reference to FIG. 1, a reference item 102 may be provided to the device 150. The reference item 102 may then be provided to a server 170 and ultimately to a device 160.

The reference item 102 may be provided by a user to the device 150. The reference item 102 (also referred to as reference data herein) may include a user's identifier by a commonly accepted identity-verification institution such as a governmental agency, bank, credit card issuer, or other financial institution. For example, a government-issued photo ID card (e.g., state-issued identification (ID), driver's license, signature or fingerprint (such as from a reference data item such as a driver's license or credit card), voiceprint, or genetic/DNA code).

In one or more embodiments, the system 100 includes functionality to receive a first source identification item, produced in real time, that is also associated with the user. For example, the first source item 104 may be provided (e.g., by a user) to the device 150, which in turn provides the first source item 104 to the server 170 and/or the device 160. The first source item 104 may be provided either around the same time or at a different time than when the reference item 102 is provided.

In another example, the first source item 104 may be provided (e.g., by a user) to a device other than device 150, which will in turn provide the first source item 104 to the server 170 and/or the device 160. For example, the reference item 102 and the first source item 104 may be provided to different devices, either around the same time or at different times.

The first source item 104 (also referred to as source data herein) may include an image (e.g., a “selfie” photo), video, audio, voice data / voiceprint, a signature, computer cursor movement, touchscreen interaction movement, a fingerprint, a retina scan, iris recognition, a heart rate, other personal biometric data, or genetic code associated with a user.

The first source item 104 may be captured in real time by the device 150. For example, the device 150 may include a camera that captures an image (e.g., of the user or of the user's signature), audio, video produced in real time by the user. In another example, the device 150 may include a computer mouse, computer pen, or touchscreen operable to receive the user's signature in real time. In yet another example, the device 150 may include a computer mouse, computer pen, computer joystick, accelerometer/gyroscope, or touchscreen operable to receive the user's movement patterns in real time for analysis and matching to previously known movement patterns. In a further example, the device 150 may include a fingerprint sensor to capture the user's fingerprint in real time, a visual scanner to scan the user's retina or iris in real time, or other input sensors for receiving biometric data like heart rate in real time.

In one or more embodiments, the first source identification item is received within a threshold amount of time. For example, the first source item 104 may be provided within 5 minutes, 15 minutes, or 60 minutes from a time the user is prompted to do so, or from a time the user provides the reference item 102.

In one or more embodiments, the system 100 includes functionality to receive a first analysis result from a first analysis operation analyzing the first source identification item with respect to the reference identification item. For example, the reference item 102 and the first source item 104 may be analyzed by an inspector 180 to determine whether there is a match. For example, the inspector 180 may be a human reviewer (aka, team member) who manually reviews the reference item 102 and the first source item 104 on a device 160.

In another example, the inspector 180 may be an analysis module that is a software or hardware module. For example, a software application, algorithm, microprocessor, etc. The analysis module may implement artificial intelligence and/or machine learning technology to automatically perform the analysis. For example, the analysis module may conduct facial recognition or identification on the reference item 102 and the first source item 104.

Although the analysis module may access the reference item 102 and the first source item 104 through the device 160, the analysis module may instead access directly or through the server 170, as opposed to through the device 160. In yet another example, the inspector 180 may include both a human reviewer and analysis module working in collaboration. In either case, the inspector 180 may provide a first analysis result (e.g., to the server 170 or otherwise) indicating whether the reference item 102 and the first source item 104 match.

The inspector 180 may analyze an image (e.g., of the user or of the user's signature), audio, video, I/O device input (mouse, keyboard, touchpad, pen, joystick, accelerometer/gyroscope, etc.), fingerprint, retina/iris scan, heart rate, genetic code, and so on, with respect to the reference item 102. For example, the inspector 180 may compare a selfie photo (source item) with a driver's license photo (reference item), a signature (source item) with a driver's license signature (reference item), a touchscreen finger movement pattern (source item) with a previously known movement pattern (reference item), a body/facial movement pattern captured by video (source item) with a previously known movement pattern (reference item), and so on.

In one or more embodiments, the inspector 180 includes functionality to verify that the first source identification item is produced in real time. One issue could be that a dishonest individual attempts to circumvent the system. For example, the dishonest individual does not correspond to the reference item 102, but presents a photo, video, or audio of the person corresponding to the reference item 102. The system 100 may prompt the user to perform acts in real time that are analyzed by the inspector 180 to confirm compliance. For example, the user may be asked to repeat a particular sentence. In the case of audio or video, clips or frames before and/or after the presentation of the source identification item can be analyzed. For example, a user may be determined to be a dishonest individual if they are detected to be performing dishonest acts before or after the presentation of the source identification item.

In one or more embodiments, the system 100 includes functionality to, upon receiving the first analysis result, delete the reference identification item. For example, the reference item 102 may be deleted from the server 170, changing the server status from server state 171 to server state 172. Accordingly, in some embodiments, the existence of the reference item 102 is “ephemeral”. As a result, rules or regulations prohibiting the storage of certain forms of identification can be abided.

In one or more embodiments, the system 100 includes functionality to authenticate the user based on the first analysis result. For example, depending on the first analysis result provided by the inspector 180, the user may be authenticated. An authentication module (not shown, that may be included in the server 170) may receive the first analysis result from the inspector 180, the authentication module may then cause the user to be authenticated, allowing the process to progress to the next stage (e.g., healthcare provision, clinical study facilitation, or any other process benefiting from identify verification). Accordingly, the authentication process may be asynchronous in that the source and reference items are analyzed for authentication at a time other than when they're provided. As a result, asynchronous consent can be achieved (whereby a user signs up and consents to a study without yet being approved).

However, depending on the first analysis result provided by the inspector 180, the user may not be authenticated, preventing the process from progressing. A failed authentication attempt may result in an additional authentication opportunity where some or all of the authentication steps are repeated, a logging of the attempt, or a flagging of the attempt for review.

In one or more embodiments, the system 100 includes functionality to perform subsequent authentication operations of the user using the persisting first source identification item. In one or more embodiments, the system 100 includes functionality to receive a second source identification item, produced in real time, associated with the user. For example, a second source item 106 may be provided via steps similar to those discussed with respect to the first source item 104. The second source item 106 may be provided to a device 152, where device 152 may be different from or the same device as device 150. The device 152 in turn provides the second source item 106 to the server 170 (see server state 173) and/or the device 160.

The second source item 106 may include or be similar items as the first source item 104. Like the first source item 104, the second source item 106 may be captured in real time by the device 150. Like the first source item 104, the second source item 106 may be received within a threshold amount of time.

In one or more embodiments, the system 100 includes functionality to receive a second analysis result from a second analysis operation analyzing the first source identification item with respect to the second source identification item. For example, the first source item 104 and the second source item 106 may be analyzed by an inspector 180. The inspector 108 may treat the first source item 104 as a reliable reference because it was earlier determined to be verified or accurate based on the reference item 102. The inspector 180 may be the same or a different inspect as the one that analyzed the first source item 104 with respect to the reference item 102, and the device 162 may be different from or the same device as device 160.

In one or more embodiments, the system 100 includes functionality to re-authenticate the user based on the second analysis result. For example, depending on the second analysis result provided by the inspector 180, the user may be authenticated. The second source item 106 may be maintained in the server 170 for potential future use as a reference item, either alone or in combination with other stored source items.

In one or more embodiments, the system 100 includes functionality to store the reference identification item in a first secure location (optionally in an encrypted form and/or with controlled access). In one or more embodiments, the system 100 includes functionality to store the first source identification item in a second secure location (optionally in an encrypted form and/or with controlled access), where the first secure location is different from the second secure location. As a result, the reference identification item and the first source identification item would not be stored in the same location. However, in some embodiments the reference identification item and the first source identification item are linked via an encrypted key. In some embodiments, once the analysis or the authentication is complete, the reference identification item is deleted from the first secure location. In some embodiments, the reference identification item is immediately and irrevocably deleted. Accordingly, in some embodiments, the existence of the reference identification item is “ephemeral”.

It should be appreciated that various components of the system 100 can be located on the same device (e.g., a server, mainframe, desktop Personal Computer (PC), laptop, Personal Digital Assistant (PDA), telephone, mobile phone, kiosk, cable box, and any other device) or can be located on separate devices connected by a network (e.g., a local area network (LAN), the Internet, etc.). Those skilled in the art will appreciate that there can be more than one of each separate component running on a device, as well as any combination of these components within a given embodiment.

For example, although the components of the devices (e.g., 150, 152, 160, and 162) and server(s) 170 are depicted as being directly communicatively coupled to one another, this is not necessarily the case. For example, one or more of the components of the system 100 may be communicatively coupled via a distributed computing system, a cloud computing system, or a networked computer system communicating via the Internet. Further, although only one device (e.g., 150, 152, 160, and 162) and server 170 is illustrated, it should be appreciated that this one computer system may represent many computer systems, arranged in a central or distributed fashion. For example, such computer systems may be organized as a central cloud and/or may be distributed geographically or logically to edges of a system such as a content delivery network or other arrangement. It is understood that virtually any number of intermediary networking devices, such as switches, routers, servers, etc., may be used to facilitate communication.

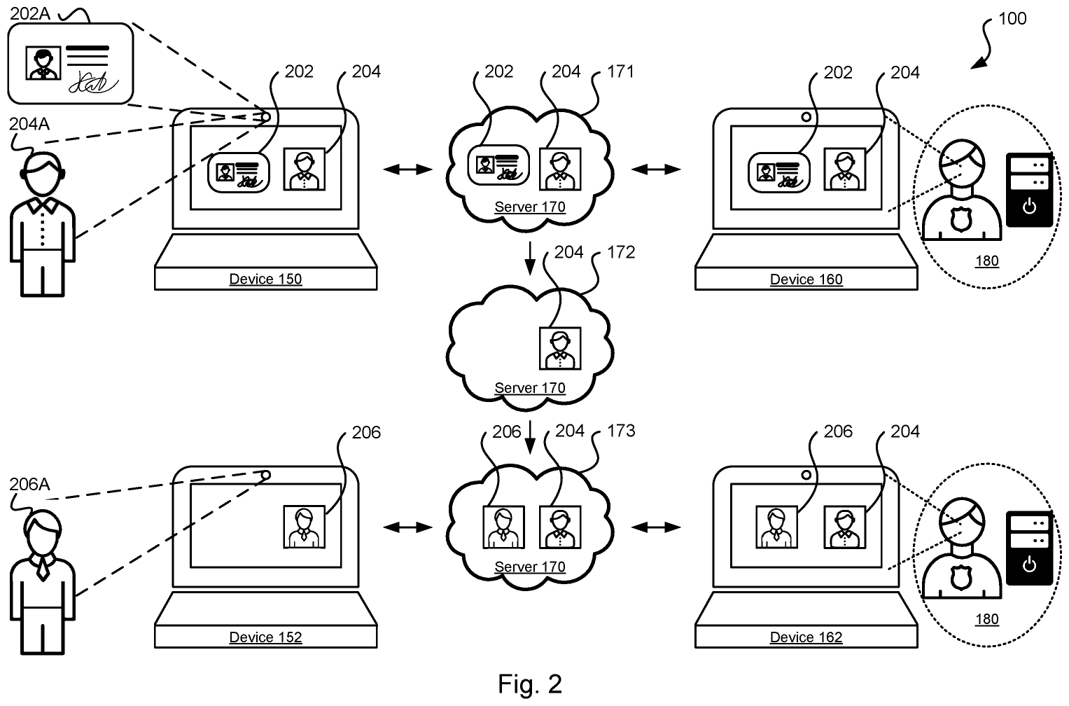

FIG. 2 illustrates a schematic diagram of a system 100, in accordance with one or more embodiments. FIG. 2 demonstrates one example workflow of system 100. For example, a user 204A may present themselves and an ID 202A to the camera of the device 150 for capture, resulting in an ID photo 202 and a selfie photo 204, respectively. The ID photo 202 and the selfie photo 204 would then be provided to the server 170 and/or device 160, and ultimately analyzed by the inspector 180. Upon the determination of a match between the ID photo 202 and the selfie photo 204, which would indicate that the user 204A is the person identified by the ID 202A, the user 204A would be authenticated. Further, the ID photo 202 may be deleted from the server 170, but the selfie photo 204 may optionally remain for future authentication processes.

Continuing the example, at a later time, a user 206A may present themselves to the camera of the device 150 for capture, resulting in a selfie photo 206. The selfie photo 206 would then be provided to the server 170 and/or device 160, and ultimately analyzed by the inspector 180. Upon the determination of a match between the selfie photo 204 and the selfie photo 206, which would indicate that the user 206A is the same person identified by the ID 202A and the selfie photo 204, the user 206A would be authenticated. Further, the selfie photo 204 and the selfie photo 206 may optionally remain for future authentication processes.

It should be appreciated that a myriad of other examples are possible. For example, instead of providing a photo 204, the user 204A could provide a signature (e.g., signed in real time using a touchscreen, computer mouse, or computer pen). The signature would then be provided to the server 170 and/or device 160, and ultimately analyzed by the inspector 180. The inspector 180 would compare the signature with the signature found on the ID 202.

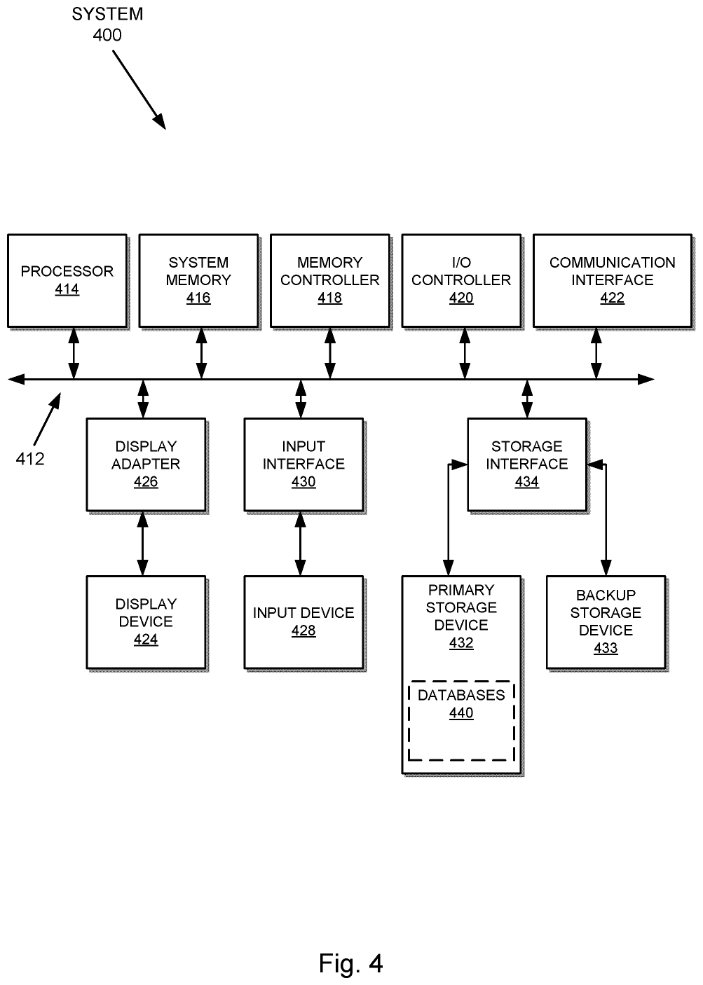

FIG. 4 shows a flowchart 400 of a method for identity verification. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 4 should not be construed as limiting the scope of the invention.

At STEP 402, a reference identification item associated with a user is received. Reference data may include data collected at an earlier time (e.g., before a threshold amount of time) than verification of a user (e.g., a Potential Patient). For example, reference data may include data collected by a government entity such as a Department of Motor Vehicles (e.g., information included in a driver's license). In one or more embodiments, reference data may include an image of the user, a signature of the user, a height and/or weight of a user, biometric data corresponding to a user such as their fingerprints or voice, etc.

At STEP 404, a first source identification item, produced in real time, that is also associated with the user is received. Source data may include data collected at a time of verification (e.g., within a threshold amount of time of a verification such as 60 seconds, 5 minutes, 30 minutes, 60 minutes). Source data may include an image of a user, a signature of a user, a height and/or weight of a user, biometric data corresponding to a user such as fingerprints or voice, etc.

At STEP 406, a first analysis result from a first analysis operation analyzing the first source identification item with respect to the reference identification item is received. For example, the result of a comparison between a previous image of a user compared to a current image of a user may be compared. A previous image of a user may be an image taken before a particular amount of time from the comparison (e.g., a driver's license picture taken a year before the comparison). A current image may be an image taken at the time of the verification/comparison (e.g., within 60 seconds, 30 minutes, 60 minutes) of the verification/comparison.

In one or more embodiments, the source data may include a signature, facial recognition data, fingerprints, tattoos, images of various body parts other than a face, etc.

At STEP 408, the reference identification item is deleted upon receiving the first analysis result. In some embodiments, multiple comparisons may be made. For example, a first comparison between a previously captured image and a current image (e.g., a “selfie” or an image captured at a testing facility) may occur, and a second comparison between a previously captured signature and a current signature may occur. Of course, in various embodiments, identifiers other than an image and/or a signature may be compared and used to verify an identity of a user.

At STEP 410, the user is authenticated based on the first analysis result. Such an authentication may be made when source data and reference data are within a certain amount. For example, a likelihood (e.g., a percentage) may be made between source data such as a current image and reference data such as an image on an ID may be determined, and if that likelihood/percentage is above a certain amount a user (e.g., a Potential Patient) may be verified. Such a verification may be made manually by a person (e.g., a Staff Member) or automatically (e.g., by an electronic device).

In response to the verification of a user, that user may be allowed to participate in a study and/or receive medicine. In some embodiments, source data and/or reference data may be received by a sensor receiving facial recognition information of a user in a facility where the testing and/or medicine dispensing takes place. In some embodiments, source data may be taken while a user is waiting in a waiting room and compared to reference data. In some embodiments, in response to a verification a user may be allowed to enter a certain room controlled by an electronic door (e.g., a door that is unlocked electronically). In one or more embodiments, a medicine dispensing machine may allow a user to receive a certain type of medication (e.g., a placebo and/or a non-placebo) in response to the result of a verification (e.g., positive or negative).

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

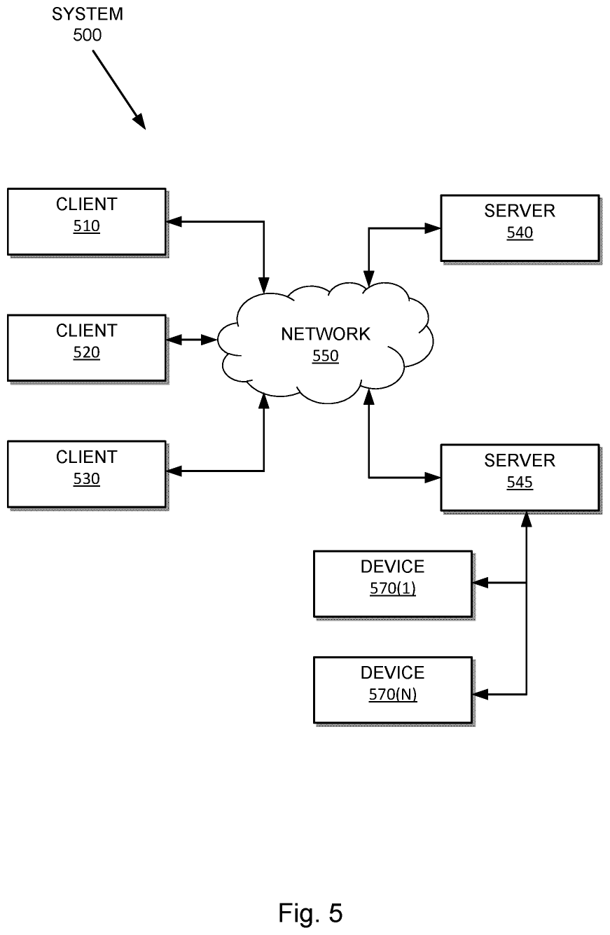

FIG. 5 is a block diagram of an example of a computing system 400 capable of implementing embodiments of the present disclosure. Computing system 400 broadly represents any single or multi-processor computing device or system capable of executing computer-readable instructions. Examples of computing system 400 include, without limitation, workstations, laptops, client-side terminals, servers, distributed computing systems, handheld devices, or any other computing system or device. In its most basic configuration, computing system 400 may include at least one processor 414 and a system memory 416.

Processor 414 generally represents any type or form of processing unit capable of processing data or interpreting and executing instructions. In certain embodiments, processor 414 may receive instructions from a software application or module. These instructions may cause processor 414 to perform the functions of one or more of the example embodiments described and/or illustrated herein.

System memory 416 generally represents any type or form of volatile or non-volatile storage device or medium capable of storing data and/or other computer-readable instructions. Examples of system memory 416 include, without limitation, RAM, ROM, flash memory, or any other suitable memory device. Although not required, in certain embodiments computing system 400 may include both a volatile memory unit (such as, for example, system memory 416) and a non-volatile storage device (such as, for example, primary storage device 432).

Computing system 400 may also include one or more components or elements in addition to processor 414 and system memory 416. For example, in the embodiment of FIG. 4, computing system 400 includes a memory controller 418, an input/output (I/O) controller 420, and a communication interface 422, each of which may be interconnected via a communication infrastructure 412. Communication infrastructure 412 generally represents any type or form of infrastructure capable of facilitating communication between one or more components of a computing device. Examples of communication infrastructure 412 include, without limitation, a communication bus (such as an Industry Standard Architecture (ISA), Peripheral Component Interconnect (PCI), PCI Express (PCIe), or similar bus) and a network.

Memory controller 418 generally represents any type or form of device capable of handling memory or data or controlling communication between one or more components of computing system 400. For example, memory controller 418 may control communication between processor 414, system memory 416, and I/O controller 420 via communication infrastructure 412.

I/O controller 420 generally represents any type or form of module capable of coordinating and/or controlling the input and output functions of a computing device. For example, I/O controller 420 may control or facilitate transfer of data between one or more elements of computing system 400, such as processor 414, system memory 416, communication interface 422, display adapter 426, input interface 430, and storage interface 434.

Communication interface 422 broadly represents any type or form of communication device or adapter capable of facilitating communication between example computing system 400 and one or more additional devices. For example, communication interface 422 may facilitate communication between computing system 400 and a private or public network including additional computing systems. Examples of communication interface 422 include, without limitation, a wired network interface (such as a network interface card), a wireless network interface (such as a wireless network interface card), a modem, and any other suitable interface. In one embodiment, communication interface 422 provides a direct connection to a remote server via a direct link to a network, such as the Internet. Communication interface 422 may also indirectly provide such a connection through any other suitable connection.

Communication interface 422 may also represent a host adapter configured to facilitate communication between computing system 400 and one or more additional network or storage devices via an external bus or communications channel. Examples of host adapters include, without limitation, Small Computer System Interface (SCSI) host adapters, Universal Serial Bus (USB) host adapters, IEEE (Institute of Electrical and Electronics Engineers) 1394 host adapters, Serial Advanced Technology Attachment (SATA) and External SATA (eSATA) host adapters, Advanced Technology Attachment (ATA) and Parallel ATA (PATA) host adapters, Fiber Channel interface adapters, Ethernet adapters, or the like. Communication interface 422 may also allow computing system 400 to engage in distributed or remote computing. For example, communication interface 422 may receive instructions from a remote device or send instructions to a remote device for execution.

As illustrated in FIG. 4, computing system 400 may also include at least one display device 424 coupled to communication infrastructure 412 via a display adapter 426. Display device 424 generally represents any type or form of device capable of visually displaying information forwarded by display adapter 426. Similarly, display adapter 426 generally represents any type or form of device configured to forward graphics, text, and other data for display on display device 424.

As illustrated in FIG. 4, computing system 400 may also include at least one input device 428 coupled to communication infrastructure 412 via an input interface 430. Input device 428 generally represents any type or form of input device capable of providing input, either computer- or human-generated, to computing system 400. Examples of input device 428 include, without limitation, a keyboard, a pointing device, a speech recognition device, or any other input device.

As illustrated in FIG. 4, computing system 400 may also include a primary storage device 432 and a backup storage device 433 coupled to communication infrastructure 412 via a storage interface 434. Storage devices 432 and 433 generally represent any type or form of storage device or medium capable of storing data and/or other computer-readable instructions. For example, storage devices 432 and 433 may be a magnetic disk drive (e.g., a so-called hard drive), a floppy disk drive, a magnetic tape drive, an optical disk drive, a flash drive, or the like. Storage interface 434 generally represents any type or form of interface or device for transferring data between storage devices 432 and 433 and other components of computing system 400.

In one example, databases 440 may be stored in primary storage device 432. Databases 440 may represent portions of a single database or computing device or it may represent multiple databases or computing devices. For example, databases 440 may represent (be stored on) a portion of computing system 400 and/or portions of example network architecture 500 in FIG. 5 (below). Alternatively, databases 440 may represent (be stored on) one or more physically separate devices capable of being accessed by a computing device, such as computing system 400 and/or portions of network architecture 500.

Continuing with reference to FIG. 4, storage devices 432 and 433 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 432 and 433 may also include other similar structures or devices for allowing computer software, data, or other computer-readable instructions to be loaded into computing system 400. For example, storage devices 432 and 433 may be configured to read and write software, data, or other computer-readable information. Storage devices 432 and 433 may also be a part of computing system 400 or may be separate devices accessed through other interface systems.

Many other devices or subsystems may be connected to computing system 400. Conversely, all of the components and devices illustrated in FIG. 4 need not be present to practice the embodiments described herein. The devices and subsystems referenced above may also be interconnected in different ways from that shown in FIG. 4. Computing system 400 may also employ any number of software, firmware, and/or hardware configurations. For example, the example embodiments disclosed herein may be encoded as a computer program (also referred to as computer software, software applications, computer-readable instructions, or computer control logic) on a computer-readable medium.

The computer-readable medium containing the computer program may be loaded into computing system 400. All or a portion of the computer program stored on the computer-readable medium may then be stored in system memory 416 and/or various portions of storage devices 432 and 433. When executed by processor 414, a computer program loaded into computing system 400 may cause processor 414 to perform and/or be a means for performing the functions of the example embodiments described and/or illustrated herein. Additionally or alternatively, the example embodiments described and/or illustrated herein may be implemented in firmware and/or hardware.

For example, a computer program for requesting advertising content for display by a thin client application may be stored on the computer-readable medium and then stored in system memory 416 and/or various portions of storage devices 432 and 433. When executed by the processor 414, the computer program may cause the processor 414 to perform and/or be a means for performing the functions required for carrying out the process described with regard to the flowcharts (discussed above).

FIG. 5 is a block diagram of an example of a network architecture 500 in which client systems 510, 520, and 530 and servers 540 and 545 may be coupled to a network 550. Client systems 510, 520, and 530 generally represent any type or form of computing device or system, such as devices 150, 152, 160, 162, and 170 of FIG. 1.

Similarly, servers 540 and 545 generally represent computing devices or systems, such as application servers or database servers, configured to provide various database services and/or run certain software applications (e.g., functionality of data repository 120 of FIG. 1). Network 550 generally represents any telecommunication or computer network including, for example, an intranet, a wide area network (WAN), a local area network (LAN), a personal area network (PAN), or the Internet.

With reference to computing system 400 of FIG. 4, a communication interface, such as communication interface 522, may be used to provide connectivity between each client system 510, 520, and 530 and network 550. Client systems 510, 520, and 530 may be able to access information on server 540 or 545 using, for example, a Web browser, thin client application, or other client software. Such software may allow client systems 510, 520, and 530 to access data hosted by server 540, server 545, or storage devices 570(1)-(N). Although FIG. 5 depicts the use of a network (such as the Internet) for exchanging data, the embodiments described herein are not limited to the Internet or any particular network-based environment.

In one embodiment, all or a portion of one or more of the example embodiments disclosed herein are encoded as a computer program and loaded onto and executed by server 540, server 545, storage devices 570(1)-(N), or any combination thereof. All or a portion of one or more of the example embodiments disclosed herein may also be encoded as a computer program, stored in server 540, run by server 545, and distributed to client systems 510, 520, and 530 over network 550.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. A method for identity verification, the method comprising:
receiving, from a first electronic device, a reference identification item associated with a user;
receiving a first source identification item, produced in real time, that is also associated with the user;
receiving a first analysis result from a first analysis operation analyzing the first source identification item with respect to the reference identification item;
upon receiving the first analysis result, deleting the reference identification item; and
authenticating the user based on the first analysis result.

2. The method of claim 1, further comprising:
upon receipt of the reference identification item, storing the reference identification item in a first secure location in an encrypted form;
upon receipt of the first source item, storing the first source identification item in a second secure location in an encrypted form, wherein the first secure location is different from the second secure location; and
linking the reference identification item to the first source identification item via an encrypted key.

3. The method of claim 1, wherein the first analysis operation includes manual analysis of the first source identification item and the reference identification item by a human reviewer.

4. The method of claim 1, wherein the first analysis operation includes automated analysis of the first source identification item and the reference identification item by an analysis module.

5. The method of claim 1, further comprising:
verifying that the first source identification item is produced in real time.

6. The method of claim 1, wherein the reference identification item comprises a government-issued identification item.

7. The method of claim 1, wherein the first source identification item comprises at least one selected from a group consisting of: an image, video, audio, voice data, a signature, computer cursor movement, touchscreen interaction movement, a fingerprint, a retina scan, iris recognition, a heart rate, and genetic code.

8. The method of claim 1, further comprising:
receiving a second source identification item, produced in real time, associated with the user;
receiving a second analysis result from a second analysis operation analyzing the first source identification item with respect to the second source identification item; and
re-authenticating the user based on the second analysis result.

9. The method of claim 8, wherein the second source identification item is received from a second electronic device different from the first electronic device.

10. The method of claim 1, wherein the first source identification item is received from the first electronic device.

11. A system for identity verification, the system comprising:
a computer processor; and
a verification module executing on the computer processor and configured to cause the computer processor to:
receive, from a first electronic device, a reference identification item associated with a user;
receive a first source identification item, produced in real time, that is also associated with the user;
receive a first analysis result from a first analysis operation analyzing the first source identification item with respect to the reference identification item;
upon receiving the first analysis result, deleting the reference identification item; and
authenticate the user based on the first analysis result.

12. The system of claim 11, wherein the verification module is further configured to cause the computer processor to:
upon receipt of the reference identification item, store the reference identification item in a first secure location in an encrypted form;
upon receipt of the first source item, store the first source identification item in a second secure location in an encrypted form, wherein the first secure location is different from the second secure location; and
link the reference identification item to the first source identification item via an encrypted key.

13. The system of claim 11, wherein the first analysis operation includes manual analysis of the first source identification item and the reference identification item by a human reviewer.

14. The system of claim 11, wherein the first analysis operation includes automated analysis of the first source identification item and the reference identification item by an analysis module.

15. The system of claim 11, wherein the verification module is further configured to cause the computer processor to:
verify that the first source identification item is produced in real time.

16. The system of claim 11, wherein the first source identification item comprises at least one selected from a group consisting of: an image, video, audio, voice data, a signature, computer cursor movement, touchscreen interaction movement, a fingerprint, a retina scan, iris recognition, a heart rate, and genetic code.

17. The system of claim 11, wherein the verification module is further configured to cause the computer processor to:
receive a second source identification item, produced in real time, associated with the user;
receive a second analysis result from a second analysis operation analyzing the first source identification item with respect to the second source identification item; and
re-authenticate the user based on the second analysis result.

18. The system of claim 17, wherein the second source identification item is received from a second electronic device different from the first electronic device.

19. The system of claim 11, wherein the first source identification item is received from the first electronic device.

20. A non-transitory computer-readable storage medium comprising a plurality of instructions for identify verification, the plurality of instructions configured to execute on at least one computer processor to cause the at least one computer processor to:
receive, from a first electronic device, a reference identification item associated with a user;
receive a first source identification item, produced in real time, that is also associated with the user;
receive a first analysis result from a first analysis operation analyzing the first source identification item with the reference identification item;
upon receiving the first analysis result, deleting the reference identification item; and
authenticate the user based on the first analysis result.
